(19) United States
(12) Patent Application Publication
(10) Pub. No.: US 2006/0170811 A1
(43) Pub. Date: Aug. 3, 2006

(54) Camera module with minimized defects caused by dirt particles on optical filter

(75) Inventor: Woo Sik Joung, Busan (KR)

Correspondence Address: LOWE HAUPTMAN BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 11/295,494

(22) Filed: Dec. 7, 2005

(30) Foreign Application Priority Data
Jan. 28, 2005 (KR) 10-2005-0008217

(51) Int. Cl. H04N 5/225

(52) U.S. Cl. 348/342

(57) ABSTRACT

Disclosed herein is a camera module with minimized defects caused by dirt particles on an optical filter for use in digital optical instruments. The camera module comprises a flexible substrate having a patterned portion, an image sensor unit mounted to an end region of the flexible substrate, a lens unit fixed to the flexible substrate and having a plurality of lenses to introduce light to the image sensor unit, an optical filter arranged in the lens unit to intercept specific wavelengths of the light that is being introduced into the lens unit, and a filter spacer located between the optical filter and the image sensor unit to distance the optical filter from the image sensor unit, so that dirt particles adhered to the optical filter are distanced from pixels of the image sensor unit so as not to shield an angle of view of the pixels.

### RELATED APPLICATIONS

The present application is based on, and claims priority from, Korean Application Number 2005-8217, filed Jan. 28, 2005, the disclosure of which is incorporated by reference herein in its entirety.

### BACKGROUND OF THE INVENTION

1. Field of the Invention

The present invention relates to a camera module for use in digital optical instruments, and more particularly, to a camera module with minimized defects caused by dirt particles on an optical filter, in which the optical filter is distanced from an image sensor to prevent dirt particles, which are adhered to the optical filter when the optical filter is assembled to a flexible substrate, from shielding an angle of view of a pixel provided on the image sensor, whereby generation of defective products due to the dirt particles can be minimized and the productivity of the camera module cab be improved while achieving a reduction in manufacturing costs.

2. Description of the Related Art

Many cellular phone manufactures are now developing and manufacturing a cellular phone of a type having a built-in camera module. In accordance with constituent elements and packaging methods thereof, various shapes of the built-in camera module for use in a cellular phone are developed.

Referring to FIG. 1, an example of a conventional camera module for use in a cellular phone is illustrated in sectional view. As shown in FIG. 1, the conventional camera module 200 includes an image sensor unit 202 located in an end region thereof, and a connector 230 located in an opposite end region thereof to be electrically connected to a main board (not shown) provided in a cellular phone. Both the image sensor unit 202 and the connector 230 are mounted to a flexible substrate 220 of the camera module 200 via a so-called chip on film (COF) technology.

The flexible substrate 220 is perforated with a through-hole 224 for the transmission of light, and the image sensor unit 202 has a light-receiving element 250 located at a side of the through-hole 224. More specifically, an image sensor 252 is mounted to one surface of the flexible substrate 220 in a flip-chip manner, and in turn, the light receiving element 250 is arranged on the image sensor 252, so that the light receiving element 250 is exposed to the outside via the through-hole 224. A resin packaging layer 254 is provided along the circumference of the image sensor 252.

The conventional camera module 200 further includes a lens unit 260 used to mount a plurality of lenses 262 to the camera module 200. The lens unit 260 is mounted to the other surface of the flexible substrate 220, so that it communicates with the light-receiving element 250 via the through-hole 224 in front of the image sensor 252.

The conventional camera module 200 having the above-described configuration includes an optical filter 270 as an essential constituent element. The optical filter 270 is able to intercept specific unnecessary wavelengths of infrared or ultraviolet rays and visible rays.

Conventionally, the optical filter 270 is formed of an infrared-blocking (IR) filter. As shown in FIG. 1, the optical filter 270 is attached to the flexible substrate 220 to be located in a housing 272 of the image sensor unit 202.

However, the conventional camera module 200 as described above has a problem in that dust and dirt particles K are inevitably adhered to the optical filter 270 when the optical filter 270 is mounted to the flexible substrate 220, thereby hindering light reception of the image sensor 252. Upon recent investigation it was found that approximately 90% of defective camera modules 200 were the result of dust and dirt particles K on the optical filter 270.

Referring to FIGS. 2A to 2C, the cause of inferior optical capacity of the conventional camera module 200, i.e. the dust and dirt particles K on the optical filter 270, is illustrated in more detail.

As shown in FIG. 2A, the conventional camera module 200 is configured such that the optical filter 270 is located close to pixels 250a provided on the light-receiving element 250 of the image sensor 252. Accordingly, if the dust and dirt particles K are adhered to the optical filter 270, the dust and dirt particles K are also located close to the pixels 250a of the light-receiving element 250. Thereby, as shown in FIG. 2B, each dust and dirt particle K shields an angle θ of view of one of the pixels 250a provided on the image sensor 252, thereby preventing light reception of the corresponding pixel 250a.

As a result, the corresponding pixel 250a exhibits a defect in light reception due to the dust and dirt particle K, and the camera module 200 having the defective pixel 250a will fall to pass quality control. Thus, there is a problem in that a large number of defective products are produced.

### SUMMARY OF THE INVENTION

Therefore, the present invention has been made in view of the above problems, and it is an object of the present invention to provide a camera module with minimized defects caused by dust and dirt particles on an optical filter, which is capable of minimizing generation of defective products due to the dust and dirt particles that are adhered to the optical filter when the optical filter is assembled to a flexible substrate, thereby enabling most products to pass quality control and achieving an increase in productivity.

It is another object of the present invention to provide a camera module, which is capable of minimizing generation of defective products due to dust and dirt particles adhered to an optical filter, thereby achieving a reduction in manufacturing costs via a reduced number of products to be disposed.

In accordance with the present invention, the above and other objects can be accomplished by the provision of a camera module, with minimized defects caused by dirt particles on an optical filter, for use in digital optical instruments, comprising: a flexible substrate having a patterned portion; an image sensor unit mounted to an end region of the flexible substrate; a lens unit fixed to the flexible substrate and having a plurality of lenses to introduce light into the image sensor unit; the optical filter arranged in the lens unit to intercept specific wavelengths of the light that is being introduced into the lens unit; and a filter spacer located between the optical filter and the image sensor unit to distance the optical filter from the image sensor unit, so that the dirt particles adhered to the optical filter are distanced from pixels provided on the image sensor unit so as not to shield an angle of view of the pixels, whereby the camera module is configured to prevent a degradation in an optical capacity thereof due to the dirt particles.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating the general configuration of a conventional camera module;

FIGS. 2A to 2C illustrate the generation of a defect due to a dirt particle in the conventional camera module of FIG. 1, FIG. 2A being a sectional view illustrating the dirt particle adhered to an optical filter, FIG. 2B being an explanatory view illustrating shielding of an angle of view of a pixel by the dirt particle on the optical filter, and FIG. 2C being an explanatory view illustrating the positional relationship between the dirt particle and the pixel in detail;

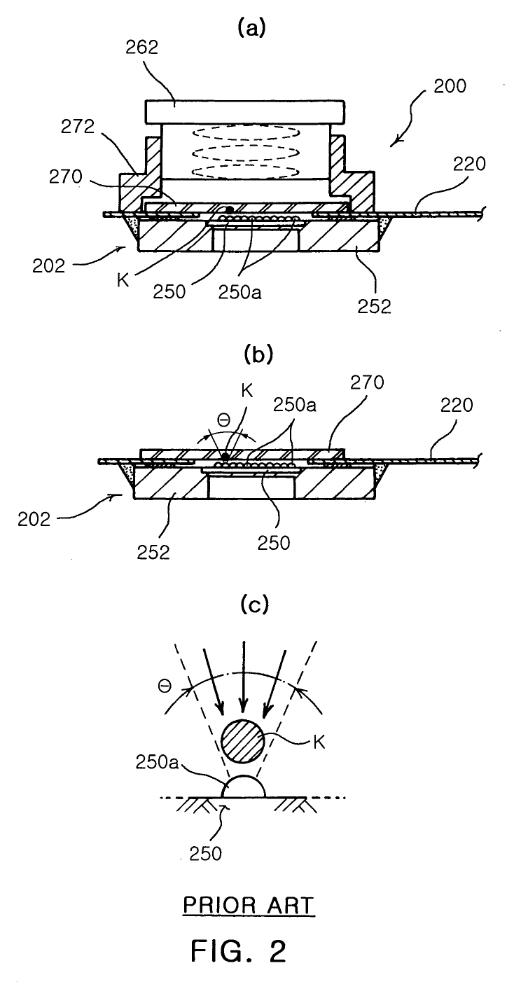

FIGS. 3A and 3B are a sectional view and a plan view, respectively, illustrating a camera module according to the present invention, in which a filter spacer is attached to a flexible substrate;

FIGS. 4A to 4C illustrate an arrangement for preventing generation of a defect due to a dirt particle in the camera module according to the present invention, FIG. 4A being a sectional view illustrating the dirt particle adhered to an optical filter, FIG. 4B being an explanatory view illustrating the dirt particle of the optical filter located in a wide sectional area of an angle of view of a pixel, and FIG. 4C being an explanatory view illustrating light reception of the pixel distanced from the dirt particle; and

FIGS. 5A and 5B are explanatory views illustrating the camera module of the present invention, which is adjusted in overall thickness (height) to be equal to that of the conventional camera module of FIG. 1, in accordance with a position adjustment of lenses provided in the camera module.

### DESCRIPTION OF THE PREFERRED EMBODIMENTS

Now, a preferred embodiment of the present invention will be explained in more detail with reference to the accompanying drawings.

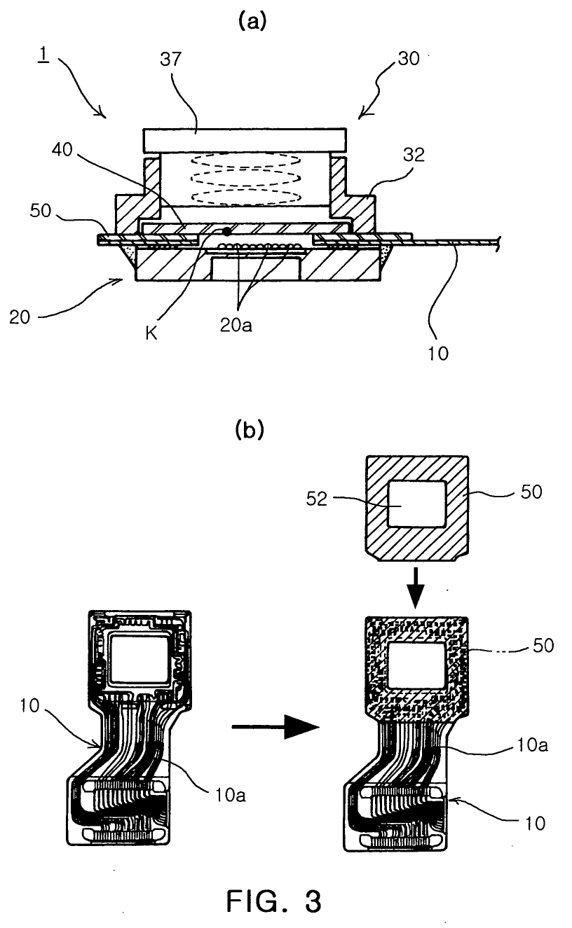

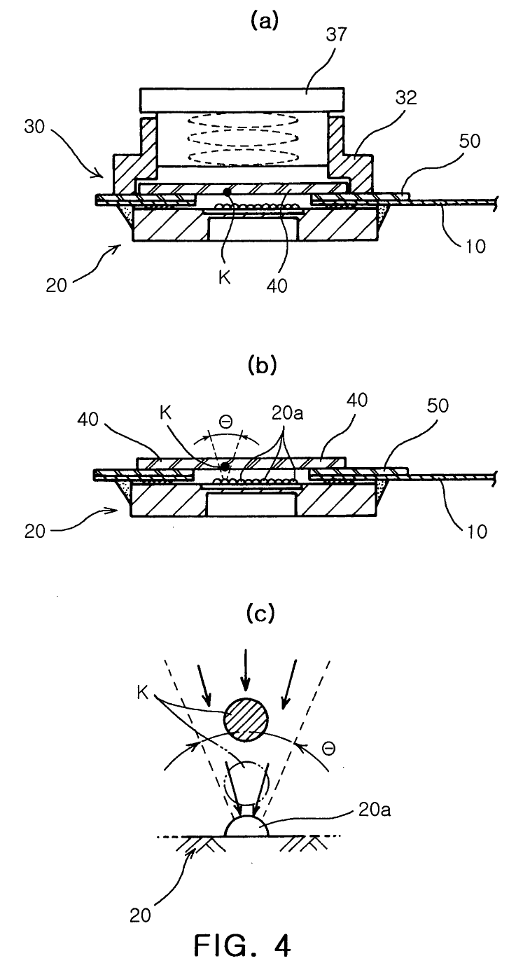

Referring to FIGS. 3A and 3B and 4A to 4C, a camera module according to the present invention, with minimized defects caused by dirt particles on an optical filter thereof, is illustrated in sectional views. As shown, the camera module of the present invention, designated as reference numeral 1, includes a flexible substrate 10 having a patterned portion 10a, an image sensor unit 20 mounted to an end region of the flexible substrate 10, and a lens unit 30 fixed to the flexible substrate 10 to introduce light into the image sensor unit 20.

The lens unit 30 is surrounded by a housing 32, so that a plurality of lenses 37 is placed within the housing 32. An optical filter 40 is arranged in the lens unit 30 to intercept specific wavelengths of light that is being introduced into the lens unit 30.

In the present invention, the camera module 1 further includes a filter spacer 50. The filter spacer 50 is interposed between the optical filter 40 and the image sensor unit 20 to distance the optical filter 40 from the image sensor unit 20. With the use of the filter spacer 50, even if a dirt particle K is adhered to the optical filter 40, the dirt particle K is distanced from pixels 20a provided on the image sensor unit 20 so as not to shield an angle θ of view.

Considering the filter spacer 50 of the present invention in detail, it is attached to the flexible substrate 10 to be interposed between the optical filter 40 and the flexible substrate 10. Preferably, the filter spacer 50 is formed of a polyimide plate having a predetermined thickness. A hole 52 is perforated at the center of the filer space 50 to pass light to the image sensor unit 20. To attach the filter spacer 50 to the flexible substrate 10 via a thermal compression process, a thermosetting adhesive is applied to a lower surface of the plate-shaped filter spacer 50. Both the optical filter 40 and the housing 32 of the lens unit 30 are affixed to an upper surface of the filter spacer 50. Here, the terms “lower surface” and “upper surface” are based on the orientation of FIG. 3A.

With the above-described configuration, the image sensor unit 20 is attached to a lower surface of the flexible substrate 10 and the optical filter 40 is spaced apart from the image sensor unit 20, so that the dirt particle K adhered to the optical filter 40 is distanced from the image sensor unit 20.

FIG. 4C illustrates a result of distancing the optical filter 40 from the image sensor unit 20. In FIG. 4C, a dotted circle indicates a dirt particle on an optical filter located close to pixels of a conventional camera module, and a solid circle indicates the dirt particle K on the optical filter 40 that is distanced from the pixels 20a of the image sensor unit 20. If the dirt particle K is distanced from the pixels 20 provided on the image sensor unit 20, the dirt particle K is moved from a narrow sectional region to a wide sectional area of an angle θ of view of one of the pixels 20a. This results in a reduction in the sectional area of the angle θ of view to be shielded by the dirt particle K.

Specifically, when the dirt particle K is located close to the corresponding pixel 20a and is located in the narrow sectional area of the angle θ of view, the dirt particle K shields the angle θ of view on the whole, resulting in a defect in the corresponding pixel 20a. However, when the dirt particle K is distanced from the corresponding pixel 20a and is located in the wide sectional area of the angle θ of view, the dirt particle K shields only part of the angle θ of view to allow light to reach the corresponding pixel 20a via the remaining part of the angle θ of view, thereby ensuring normal operation of the corresponding pixel 20a and eliminating the generation of a defective product.

As stated above, the filter spacer 50 of the present invention is attached to the flexible substrate 10, thereby serving to support both the optical filter 40 and the housing 32 of the lens unit 32, but the present invention is not limited thereto. Admittedly, the filter spacer 50 may be configured to support only the optical filter 40, so that the housing 32 of the lens unit 30 is directly attached to the flexible substrate 10.

In the latter case, as compared to the case wherein the filter spacer 50 supports the optical filter 30 and the lens unit 30 together, an attachment area of the plate-shaped filter spacer 50 relative to the flexible substrate 10 is slightly reduced.

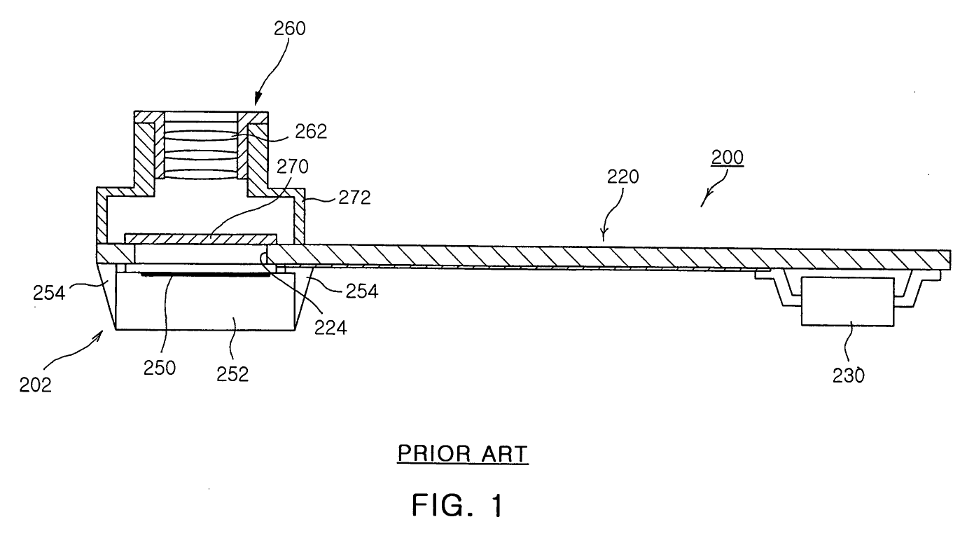

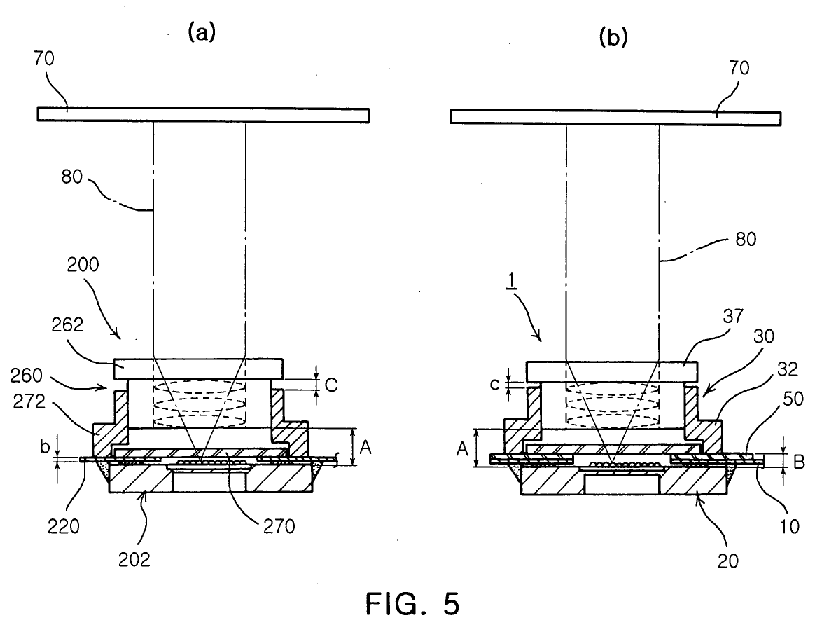

Referring to FIGS. 5A and 5B, it should be understood that, even if the optical filter 40 is distanced from the image sensor unit 20 as compared to the conventional camera module 200 of FIG. 1, the overall thickness (height) of the camera module 1 according to the present invention can be adjusted to be equal to that of the conventional camera module 200 by adjusting the position of the lenses 37 provided in the lens unit 30.

Such an adjustment in the overall thickness of the camera module 1 has the effect of achieving successful focusing of the lens unit 30 provided in the camera module 1. Comparing FIG. 5A, which illustrates the conventional camera module 200 of FIG. 1, with FIG. 5B, which illustrates the camera module 1 of the present invention, the image sensor unit 20 of the camera module 1 according to the present invention and the image sensor unit 202 of the conventional camera module 200 are spaced apart from a focusing chart 70 by the same distance as each other.

In the conventional camera module 200, the optical unit 270 and the lens unit 260 are spaced apart from the pixels by a distance (b), i.e. the thickness of the flexible substrate 220 as shown in FIG. 5A. On the other hand, the optical filter 40 and the lens unit 30 provided in the camera module 1 of the present invention are spaced apart from the pixels by an increased distance (B), i.e. the total thickness of the filter spacer 50 and the flexible substrate 10. That is, as compared to the conventional camera module 200, the optical filter 40 and the lens unit 30 are farther from the pixels by a thickness (B-b) of the filter spacer 50.

In spite of the increased distance (B) of the present invention, the lenses 37 of the lens unit 30 and the lenses 262 of the lens unit 260 must be spaced apart from the image sensor units 20 and 202, respectively, by the same distance A, to enable the focusing of the lenses 37 and 262 to be equal to each other. For this, as shown in FIGS. 5A and 5B, the camera module 1 of the present invention differs from the conventional camera module 200 in the mounting position of the lenses 37 relative to the housing 32 of the lens unit 30.

Specifically, referring to FIG. 5A illustrating the conventional camera module 200, the lenses 262 are spaced apart from an upper end of the housing 272 by a gap (C). On the other hand, referring to FIG. 5B illustrating the camera module 1 of the present invention, the lenses 37 are spaced apart from an upper end of the housing 32 by a decreased gap (c). From the description given heretofore, accordingly, the following equation 1 can be obtained.
Gap(C)−Gap(c)=Distance(B)−Distance(b) Equation 1

In conclusion, the camera module 1 of the present invention generally can keep the same thickness (height) as that of the conventional camera module 200 as a result of assembling the lenses 37 in the housing 32 of the lens unit 30 at an adjusted position, to compensate for the thickness of the plate-shaped filter spacer 50.

In FIGS. 5A and 5B, dash dotted lines indicate optical axes 80.

As stated above, in the case of the camera module 1, with minimized defects caused by the dirt particles on the optical filter, according to the present invention, the plate-shaped polyimide filter spacer 50 having a predetermined thickness is attached to the flexible substrate 10 to be interposed between the optical filter 40 and the flexible substrate 10, so that the dirt particle K, adhered on the optical filter 40, is distanced from the image sensor unit 20 by the thickness of the filter spacer 50.

By distancing the optical filter 40 from the image sensor unit 20, as indicated by the solid circle in FIG. 4C, the dirt particle K on the optical filter 40 is farther from the pixel 20a provided on the image sensor unit 20 by the thickness of the filter spacer 50, as compared to the conventional camera module 200. Thereby, the dirt particle K is moved from a narrow sectional region to a wide sectional area of the angle θ of view of the pixel 20a provided on the image sensor unit 20, resulting in a reduction in the sectional area of the angle θ of view to be shielded by the dirt particle K.

In the case of the conventional camera module 200, the dirt particle K adhered on the optical filter 40 is close to the image sensor unit 20 to shield the narrow sectional region of the angle θ of view of the pixel 20a provided on the image sensor unit 20, thereby preventing light from reaching the pixel 20a and causing a defect in the corresponding pixel 20a. However, according to the present invention, since the dirt particle K on the optical filter 40 is distanced from the pixel 20a by the thickness of the filter spacer 50, the dirt particle K shields only part of the sectional area of the angle θ of view, thereby allowing sufficient light to reach the corresponding pixel 20a to ensure normal operation of the pixel 20a.

The plate-shaped polyimide filter spacer 50 preferably has a thickness of approximately 0.4 mm, but the present invention is not limited thereto. Admittedly, it should be understood that the thickness of the filter spacer 50 can be freely selected from among various values so long as it is sufficient to prevent the dirt particle K on the optical filter 40 from shielding the angle θ of view of the pixel 20a and to ensure normal operation of the pixel 20a.

Also, although the filter spacer 50 of the present invention is made of a polyimide material and is attached to the flexible substrate 10 by use of a thermosetting adhesive as stated above, the present invention is not limited thereto, and other equivalent materials and adhesives may be used to constitute the filter spacer 50.

As apparent from the above description, the present invention provides a camera module in which a filter spacer is interposed between an optical filter and an image sensor unit to distance the optical filter from the image sensor unit, thereby allowing a dirt particle adhered to the optical filter to be distanced from a pixel provided on the image sensor unit.

Accordingly, the dirt particle is moved from a narrow sectional region to a wide sectional area of an angle of view of the pixel provided on the image sensor unit, so that the dirt particle shields only a reduced sectional area of the angle of view. This enables successful light reception of the pixel, thereby minimizing generation of a defective pixel due to the dirt particle adhered on the optical filter.

As a result, the present invention enables most manufactured camera modules to pass quality control and achieves an increase in productivity.

Also, according to the present invention, generation of defective pixels due to the dirt particle adhered to the optical filter is minimized, whereby the number of camera modules to be disposed and manufacturing costs thereof can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A camera module, with minimized defects caused by dirt particles on an optical filter, for use in digital optical instruments, comprising:
a flexible substrate having a patterned portion;
an image sensor unit mounted to an end region of the flexible substrate;
a lens unit fixed to the flexible substrate and having a plurality of lenses to introduce light into the image sensor unit;
the optical filter arranged in the lens unit to intercept specific wavelengths of the light that is being introduced into the lens unit; and
a filter spacer located between the optical filter and the image sensor unit to distance the optical filter from the image sensor unit, so that the dirt particles adhered to the optical filter are distanced from pixels provided on the image sensor unit so as not to shield an angle of view of the pixels,
whereby the camera module is configured to prevent a degradation in an optical capacity thereof due to the dirt particles.

2. The camera module as set forth in claim 1, wherein the filter spacer is formed of a polyimide plate, and is thermally compressed to be attached to the flexible substrate by use of a thermosetting adhesive.

3. The camera module as set forth in claim 1, wherein the filter spacer is configured to support and affix both the optical filter and the lens unit relative to the flexible substrate.

4. The camera module as set forth in claim 1, wherein the filter spacer is configured to support and affix only the optical filter, except for the lens unit, relative to the flexible substrate.

5. The camera module as set forth in claim 1, wherein a thickness of the filter spacer is selectable within a range suitable to prevent the dirt particles on the optical filter from shielding the angle of view of the pixels and to ensure normal operation of the pixels.

6. The camera module as set forth in claim 5, wherein the thickness of the filter spacer is approximately 0.4 mm.

7. The camera module as set forth in claim 1, wherein the position of the lenses within the housing of the lens unit is adjusted to compensate for the thickness of the filter spacer, to achieve uniform lens focusing.

8. The camera module as set forth in claim 2, wherein the filter spacer is configured to support and affix both the optical filter and the lens unit relative to the flexible substrate.

9. The camera module as set forth in claim 2, wherein the filter spacer is configured to support and affix only the optical filter, except for the lens unit, relative to the flexible substrate.
